(19) United States
(12) Patent Application Publication
(10) Pub. No.: US 2008/0147922 A1
(43) Pub. Date: Jun. 19, 2008

(54) KVM SWITCH

(75) Inventor: Cheng-Sheng Chou, Pan-chiao City (TW)

Correspondence Address: JUNE-ON CO., LTD., P.O. BOX 108-00403, TAIPEI 106, omitted

(73) Assignee: JUNE-ON CO., LTD., Pan-chiao City (TW)

(21) Appl. No.: 11/536,689

(22) Filed: Sep. 29, 2006

(51) Int. Cl. G06F 13/38

(52) U.S. Cl. 710/62

(57) ABSTRACT

A KVM switch is disclosed. The KVM switch comprises a HUB capable of switching along with a console unit to connect to a computer host or regularly connect to the computer host by pressing a hot-key command or a OSD (on screen display) of the KVM according to the user's requirement.

### BACKGROUND OF THE INVENTION

1. Field of the Invention

The present invention generally relates to a KVM switch, and more particularly to a KVM switch capable of setting up the HUB to connect to the peripheral devices and automatically detecting for switching as well setting up the computer interface.

2. Description of the Related Art

The present KVM switch on the market is mostly the operation device of a console, for example, mouse and keyboard. Some KVM switch has a HUB. The HUB is provided in the KVM switch for basic function but can not connect to a computer host controlled by the KVM switch, or the HUB can only switch along with the console to the different computers and cannot connect to the various computers without switching along with the console according to the user's requirement.

Besides, the computer interface of the switch must be the PS/2 (the IBM standard interface for the PC) or the USB (universal serial bus) according to the connected computer, or include an external adaptor for conversion. The user may choose to pay more money to buy the device with both the PS/2 port and the USB port, and the manufacturers' makes the user inconvenient from changing the computer connection interface.

### SUMMARY OF THE INVENTION

According to an aspect of the present invention, the KVM switch comprises a HUB capable of switching along with the console unit to connect to the computer host or regularly connect to the computer host by pressing the hot-key command or the OSD (on screen display) according to the user's requirement.

In accordance with the above objective of the present invention, the KVM switch comprises a housing enclosing a hollow space; a panel positioned at a side of the housing and comprising at least a first opening, a second opening and a third opening; a printed circuit board disposed in the hollow space for loading components, such as, a first switch circuit positioned on the printed circuit board and having a distal end coupled to a HUB with an up-link port in the third opening; a console unit positioned on the printed circuit board in the second opening and coupled to the first switch circuit with at least one peripheral device connection port; a microcontroller positioned on the printed circuit board and coupled to the first switch circuit and the console unit to control the operation of the first switch circuit and the console unit; a second switch circuit positioned on the printed circuit board and coupled to the microcontroller; and at least one computer connection port positioned in the first opening and coupled to the second switch circuit for connecting to at least one computer host.

According to another aspect of the present invention, the computer connection interfaces unit comprise all-in-one HDB-15 VGA connector with a built-in PS/2 interface for connecting to a standard USB-B adaptor through a USB/PS/2 conversion circuit, or a USB signal are in the same all-in-one HDB-15 VGA connector, and the microprocessor in the KVM switch judges whether or not the PS/2 interface adaptor or the USB-B adaptor is connected to switch to the proper hardware interface and execute the corresponding interface firmware. Alternatively, the user can press the hot-key command or the OSD (on screen display) to setup the computer connection interface. Thus, the requirements of the user may be implemented by using the external computer interface.

According to another aspect of the present invention, a distal end of the all-in-one HDB-15 VGA cable may be coupled to the KVM switch. The other distal end comprises a VGA connector and a USB or PS/2 connector for connecting to a computer host.

In accordance with the above objectives of the present invention, the KVM switch comprises a housing enclosing a hollow space; a panel positioned at a side of the housing and comprising at least an opening; a printed circuit board disposed in the hollow space for loading components, such as, a microcontroller positioned on the printed circuit board to control the operation of the KVM switch; and at least one computer connection interface unit positioned on the printed circuit board and coupled to the microcontroller for connecting to a computer host or at least one computer peripheral device.

According to an embodiment of the present invention, the all-in-one HDB-15 VGA cable comprises a first adaptor for coupling to a KVM switch; a cable having a distal end coupled to the first adaptor and another end spilt to a main cable and at least one secondary cable; a second adaptor coupled to the main cable for connecting to a monitor; and at least one third adaptor coupled to the secondary cable for connecting to a computer peripheral device.

### BRIEF DESCRIPTION OF THE DRAWING

FIG. 1 is a block diagram of a printed circuit board according to an embodiment of the present invention.

FIG. 2 is a block diagram of a printed circuit board according to an embodiment of the present invention.

FIG. 3 is a block diagram of a printed circuit board according to an embodiment of the present invention.

FIG. 4 is a block diagram of a printed circuit board according to another embodiment of the present invention.

FIG. 5 is an elevational view showing an application of the present invention.

FIG. 6 is an elevational view showing another application of the present invention.

### DETAIL DESCRIPTION OF THE INVENTION

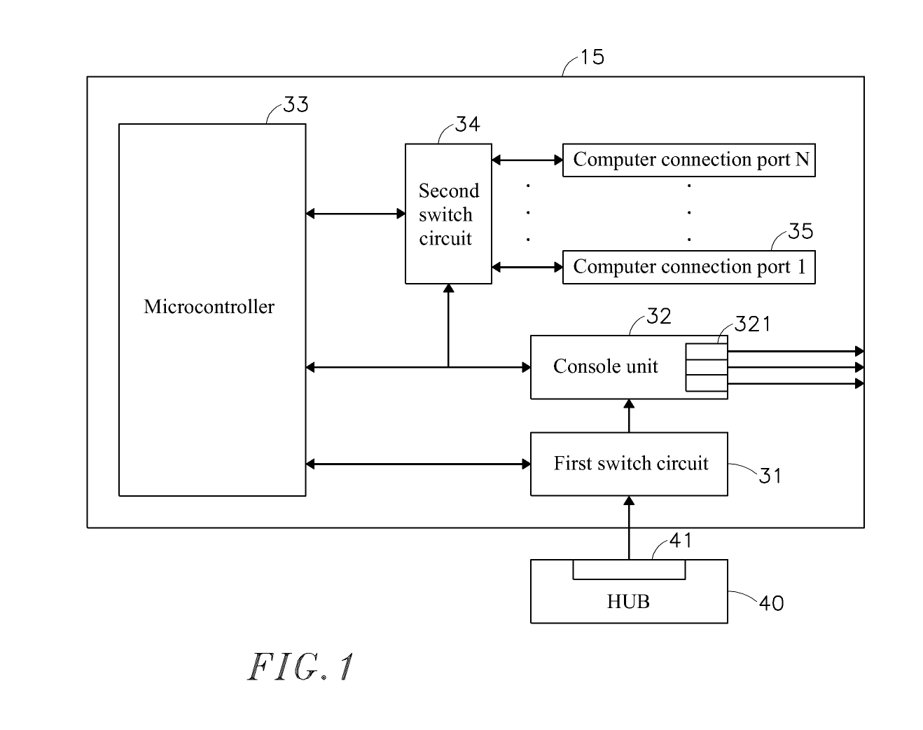

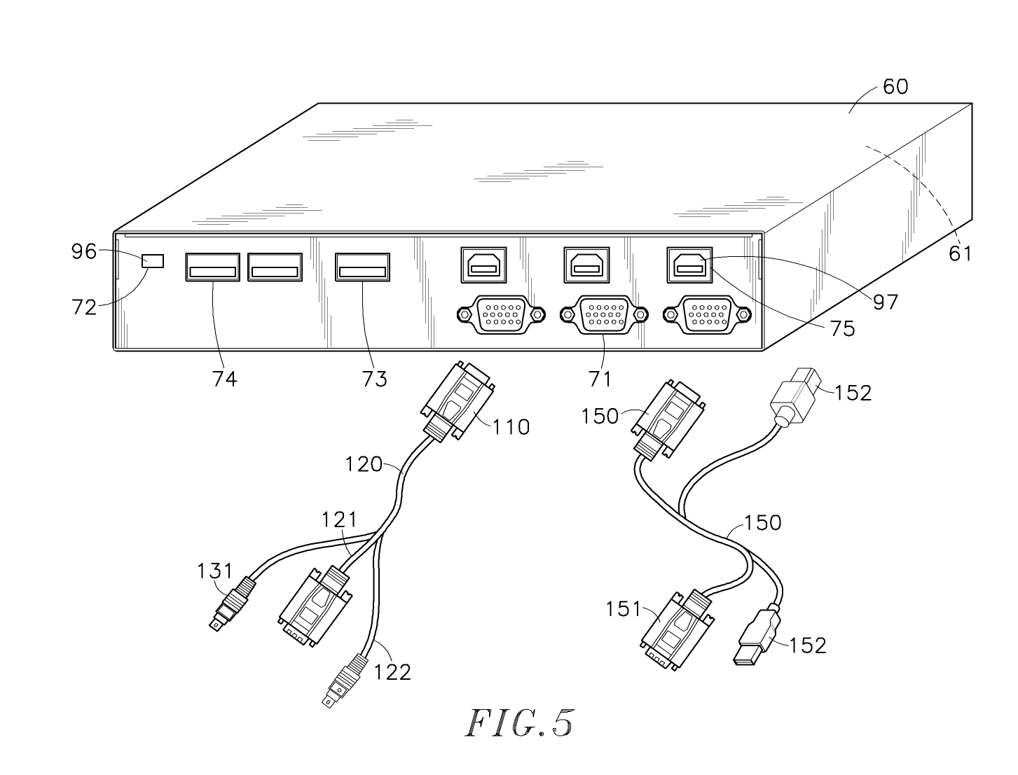

Referring to FIGS. 1 and 5, a KVM (Keyboard Vga Mouse) switch of the present invention comprises a housing 10 (as shown in FIG. 5), a printed circuit board 15, a panel 20 (as shown in FIG. 5), a first switch circuit 31, a console unit 32, a microcontroller 33, a second switch circuit 34 and at least one computer connection port 35.

The housing 10 comprises a hollow space 11 (referring to FIG. 5) for mounting the printed circuit board 15, the panel 20, the first switch circuit 31, the console unit 32, the microcontroller 33, the second switch circuit 34 and the computer connection port 35.

The panel 20 is positioned at a side of the housing 10 and can be inlayed with the housing 10, and the panel 20 has at least three openings, namely a computer connection port opening 21, a console unit peripheral device port opening 23 and a HUB port opening 24 (referring to FIG. 5).

The first switch circuit 31 is positioned on the printed circuit board 15 and having a distal end connecting to a HUB 40. The HUB 40 has an up-link port 41.

The console unit 32 is positioned on the printed circuit board 15 and coupled to the first switch circuit 31. The console unit 32 comprises at least one peripheral device connection port 321 for connecting to at least one computer peripheral device, for example, a mouse, a monitor or a display device. These examples are only for the purpose of demonstrating the embodiment and are not intended for limiting the scope of the present invention.

The microcontroller 33 is positioned on the printed circuit board 15 and coupled to the first switch circuit 31 and the console unit 32 for controlling the first switch circuit 31 and the console unit 32.

The second switch circuit 34 is positioned on the printed circuit board 15 and coupled to the microcontroller 33.

The computer connection port 35 is positioned in the openings 21 and is coupled to the second switch circuit 34 for connecting to at least one computer host (not shown).

Furthermore, the KVM switch of the present invention also comprises at least one indicator 36 (as shown in FIG. 5). The panel 20 further comprises at least one second opening 22. The indicator 36 is positioned in the second opening 22 and is coupled to the microcontroller 33 to indicate the status of the HUB 40.

The HUB 40 may switch the status via a hot-key command or an OSD (on screen display) of a computer host. The hot-key command includes, for example but not limited to, <Ctrl><Ctrl>, <Caps Lock><Caps Lock>, Ctrl+Alt or any other combination.

As shown in FIG. 1, the HUB 40 can be setup switching along with the console unit 32, and the HUB 40 can serve as an expanding device for the console unit 32.

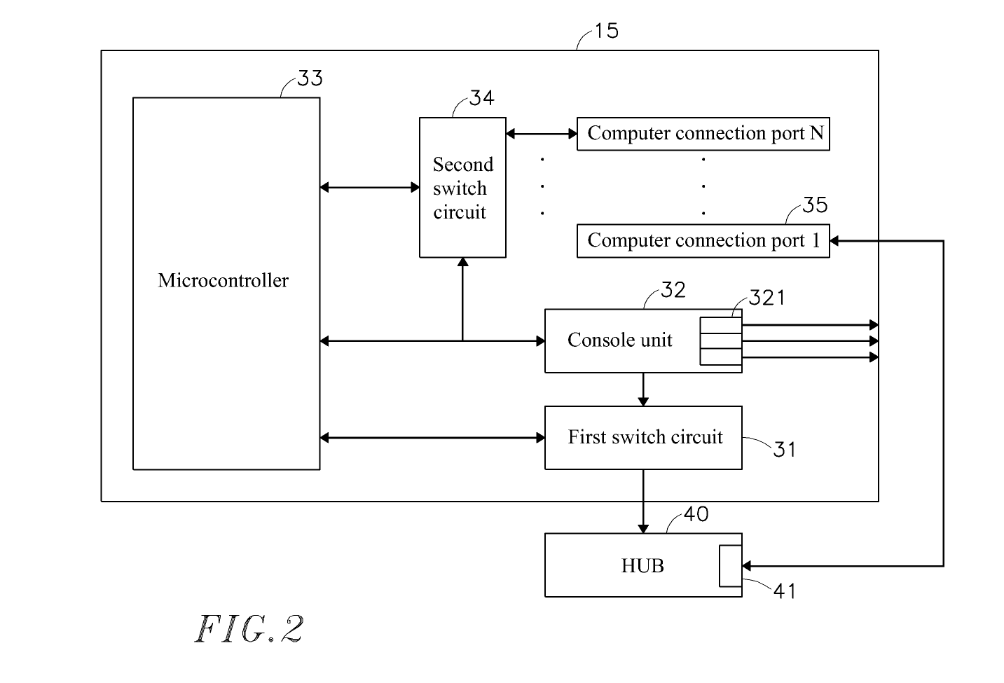

Referring to FIG. 2, the HUB 40 in the present invention is setup to directly link to the computer port 35 and the console unit 32 is switched to setup the computer connection port 35. When the up-link port 41 of the HUB 40 is linked to the console unit 32 through the first switch circuit 31 or directly connected to the computer connection port 35, and the HUB 40 is setup to switch along with the console unit 32, the microcontroller 33 links the up-link port 41 of the HUB 40 to the console unit 32 through the first switch circuit 31; meanwhile, the console unit 32 serves as the expanding device of the HUB 40.

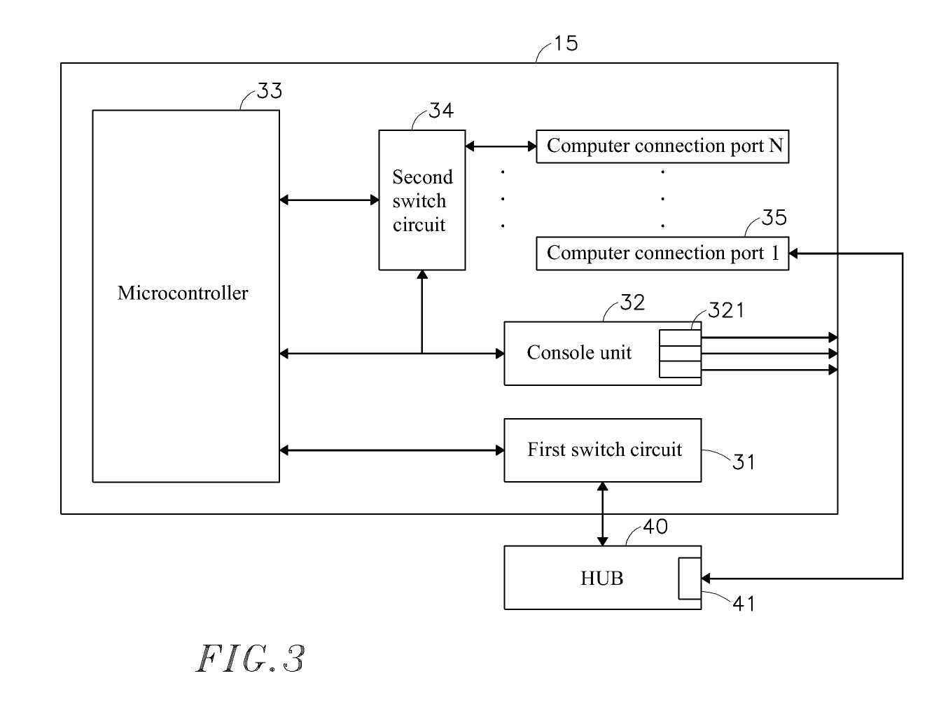

Referring to FIG. 3, the HUB 40 is setup to directly link to the computer connection port 35, and the console unit 32 is disconnected from the computer connection port 35 to link to the second switch circuit 34. When the HUB 40 is setup to directly connected to the computer connection port 35, the microcontroller 33 links the up-link port 41 of the HUB 40 to the computer connection port 35 through the first switch circuit 31, and at the same time, the console unit 32 is switched to connect to an inner connection port of the HUB 40; thus the mouse, the keyboard and the other devices connected to the console unit 32 can control the connected computer host via the HUB 40. Besides, when the console unit 32 is switched to other non-setup computer connection port 35, the console unit 32 is disconnected from the HUB 40 to link to the second switch circuit 34, simultaneously, the connection between the computer connection port 35 and the HUB 40 is not affected.

Therefore, the HUB 40 in the present invention can be setup to switch along with the console unit 32 to the computer host according to a user's need, or setup to regularly link to the computer host. The setup can be done by pressing the hot-key command or the OSD. The hot-key command includes, for example but not limited to, <Ctrl><Ctrl>, <Caps Lock><Caps Lock>, Ctrl+Alt or any other combination.

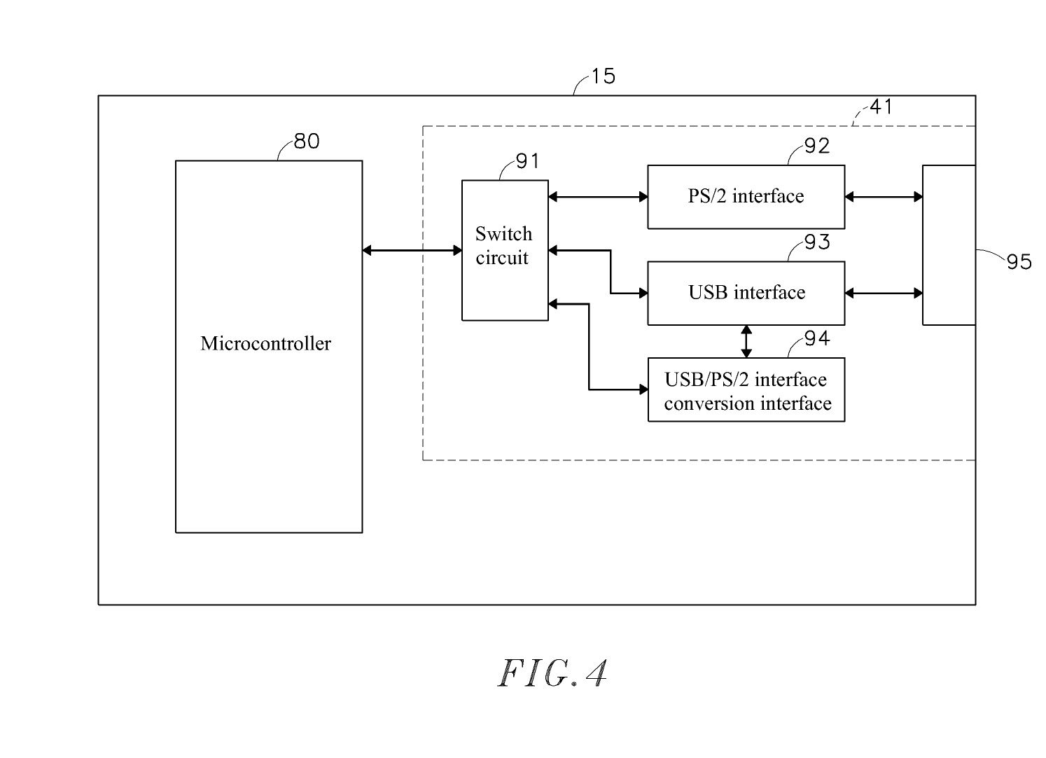

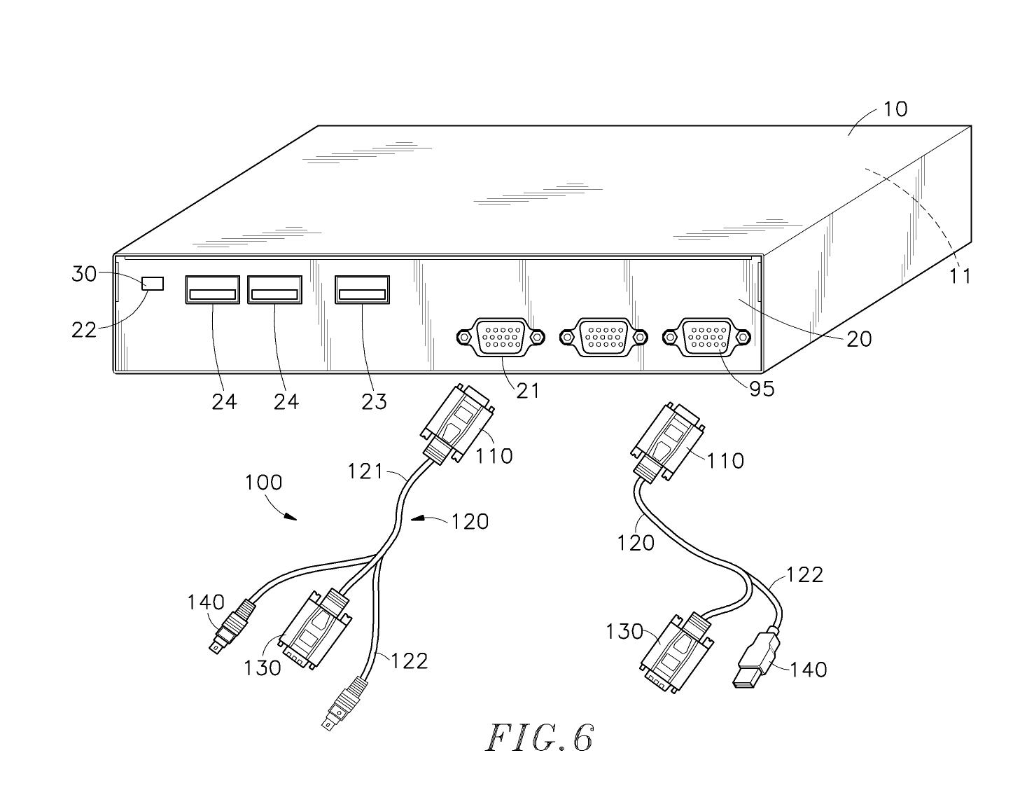

Referring to FIGS. 4 and 6, a KVM switch of the present invention comprises a housing 60, a panel 70, a printed circuit board 65, a microcontroller 80 and at least one computer connection interface unit 90.

The housing 60 has a hollow space 61 for mounting the printed circuit board 65, the panel 70, the microcontroller 80 and the computer connection interface unit 90.

The panel 70 is positioned at a side of the housing 60 and can be inlayed with the housing 60, and the panel 70 has at least one opening 71.

The microcontroller 80 is positioned on the printed circuit board 65 for controlling the KVM switch.

The computer connection interface unit 90 is positioned on the printed circuit board 65 and is coupled to the microcontroller 80 to connect to a computer host (not shown) or a peripheral device (not shown), for example, a mouse, a monitor or a display device. These examples are only for the purpose of demonstrating the embodiment and are not intended for limiting the scope of the present invention.

The computer connection interface unit 90 further comprises a switch circuit 91, a PS/2 interface 92, a USB interface 93, a USB/PS/2 interface conversion circuit 94 and a connector 95.

The switch circuit 91 is positioned on the printed circuit board 65 and is coupled to the microcontroller 80 to execute the conversion between the PS/2 interface 92 and the USB interface 93.

The PS/2 interface 92 is positioned on the printed circuit board 65 and is coupled to the switch circuit 91, and can be connected to the computer peripheral device (not shown) with the PS/2 interface; for example, a mouse, a monitor or a display device. These examples are only for the purposes of demonstrating the embodiment of the present invention, and are not intended for limiting the scope of the present invention.

The USB interface 93 is positioned on the printed circuit board 65 and is coupled to the switch circuit 91, and can be connected to the computer peripheral device (not shown) via the USB interface; for example, a mouse, a monitor or a display device. These examples are only for the purpose of demonstrating the embodiment, and are not intended for limiting the scope of the present invention.

The USB/PS/2 interface conversion circuit 92 is positioned on the printed circuit board 65 and is coupled to the switch circuit 91 to execute the conversion between the PS/2 interface 92 and the USB interface 93.

The connector 95 can be exposed out of an opening 71 and coupled to the PS/2 interface 92 and the USB interface 93 for connecting the computer host or the peripheral device with the PS/2 interface and the USB interface. The connector 95 is a HDB-15 adaptor.

Besides, the KVM switch of the present invention further comprises at least one indicator 96, and the panel 70 further comprises at least one second opening 72. The indicator 96 is positioned in the second opening 72 and is coupled to the microcontroller 80.

Referring to FIG. 5, a HDB-15 cable 100 comprises a first adaptor 110, a cable 120, a second adaptor 130 and at least one third adaptor 140.

The first adaptor 110 is a HDB-15 adaptor and is coupled to a connector 95 of the KVM switch.

The cable 120 has a distal end for coupling to the first adaptor 110 and a second distal end to split as a main cable 121 and at least a secondary cable 122.

The second adaptor 130 can be, for example but not limited, a VGA adaptor, to couple to the main cable 121 for connecting to a monitor.

The third adaptor 140 can be, for example but not limited to, a PS/2 adaptor or a USB adaptor, to couple to the secondary cable 122 for connecting to the computer peripheral device with the PS/2 interface or the USB interface.

Referring to FIG. 6, the KVM switch further comprises at least one USB connector 97, and the panel 70 also comprises at least one third opening 73. The USB connector 97 is coupled to the USB interface 93 and is positioned in the third opening 73 for connecting to the computer peripheral device (not shown) via the USB interface. The USB connector 97 is a USB-B adaptor.

The present invention not only can have a HDB-15 cable 100 to couple a monitor to a computer peripheral device with at least one PS/2 interface or a USB interface, but also can have a cable 150 having a HDB-15 adaptor 151 and a USB connector 152 at one distal end to connect the connector 95 and the USB connector 97 of the KVM switch, and a HDB-15 adaptor 151 and a USB connector 152 of the cable 150 at another distal end are connected to the monitor and the computer peripheral device.

The user can connect the computer host to the connector 95 through the cable with different interfaces, and the switch circuit 91 can automatically switch to the PS/2 interface 92 or the USB interface 93 according to a cable signal, and further to shut down the invalid interface.

The embodiment of the present invention enables the user to press the hot-key command or the OSD of the KVM switch to setup the computer connection interface unit 90; the switch circuit 91 automatically switches to the PS/2 interface 92 or the USB interface 93 according to the command, but not the cable signal.

Therefore, the HUB in the present invention can be setup to switch along with the console unit to the computer host according to the user's need, or setup to connect to the computer host regularly. The present invention also provide the computer connection port interface capable of automatically switching or setup in advance so that the user can press hot-key command or the OSD of the KVM switch to setup the connection between the HUB and the computer connection interface. Thus, the present invention is more advantageous than the conventional art.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A KVM switch, comprising
a housing, enclosing a hollow space;
a panel, positioned at a side of said housing, comprising at least one opening;
a printed circuit board, positioned in said hollow space for carrying following components;
a first switch circuit, positioned on said printed circuit board, comprising a distal end for coupling to a HUB having an up-link port;
a console unit, positioned on said printed circuit board, comprising a distal end for coupling to said first switch circuit and having at least one peripheral device connection port;
a microcontroller, positioned on said printed circuit board, comprising a distal end for coupling to said first switch circuit and said console unit and for controlling said first switch circuit and said console unit;
a second switch circuit, positioned on said printed circuit board, comprising a distal end for coupling to said microcontroller; and
at least one computer connection port, positioned in said opening and coupled to said second switch circuit, comprising a distal end for connecting to at least one computer host.

2. A KVM switch according to claim 1, wherein said peripheral device connection port is connected to a mouse, a monitor or a monitor.

3. A KVM switch according to claim 2, wherein when said up-link port of said HUB is connected to said console via said first switch circuit or directly connected to said computer connection port, and said HUB is setup to switch along with said console unit, said microcontroller connects said up-link port of said HUB to said peripheral device connection port of said console unit through said first switch circuit, and said HUB serves as an expanding device for said console unit.

4. A KVM switch according to claim 1, wherein when said HUB is setup to directly connect to said computer connection port, said microcontroller is connected said up-link port of said HUB to said computer connection port through said first switch circuit, said console unit is switched to an inner connection port of said HUB, and basic devices connected to said console unit can control said connected computer host via HUB.

5. A KVM switch according to claim 1, wherein when said console unit is switched to another non-setup computer connection port, said console unit is disconnect from said HUB and restore connection to said peripheral device connection port, and a setup connection between said computer host and said computer connection port is unaffected.

6. A KVM switch according to claim 1, further comprises at least one indicator; said panel further comprises at least one second opening, and said indicator is positioned in said second opening and coupled to said microcontroller for indicating setup status of said HUB.

7. A KVM switch according to claim 6, wherein said HUB switches said setup status by pressing a hot-key command or on screen display (OSD) of said computer host.

8. A KVM switch according to claim 7, wherein said hot-key command comprises <Ctrl><Ctrl>, <Caps Lock><Caps Lock>, Ctrl+Alt.

9. A KVM switch, comprising
a housing, enclosing a hollow space;
a panel, positioned at a side of said housing, comprising at least one opening;
a printed circuit board, positioned in said hollow space, for carrying following components;
a microcontroller, positioned on said printed circuit board, for controlling said KVM switch; and
at least one computer connection interface unit, positioned on said printed circuit board and coupled to said microcontroller, for connecting to a computer host or a computer peripheral device.

10. A KVM switch according to claim 9, wherein said computer connection interface unit comprises:
a switch circuit, positioned on said printed circuit board and coupled to said microcontroller;
a PS/2 interface, positioned on said printed circuit board and coupled to said switch circuit for connecting said computer peripheral device with a PS/2 interface;
a USB interface, positioned on said printed circuit board and coupled to said switch circuit for connecting said computer peripheral device with a USB interface;
a USB/PS/2 interface conversion circuit, positioned on said printed circuit board and coupled to said switch circuit for switching signals between said PS/2 interface and said USB interface; and
a connector, exposed out of said opening and coupled to said PS/2 interface and said USB interface for connecting said computer host or said peripheral device with a PS/2 interface or a USB interface.

11. A KVM switch according to claim 10, wherein said computer peripheral device can be a mouse, a monitor or a monitor.

12. A KVM switch according to claim 10, further comprises at least one indicator; said panel further comprises at least one second opening, and said indicator is positioned in said second opening and coupled to said microcontroller for indicating setup status of a HUB.

13. A KVM switch according to claim 10, further comprises a USB connector; said panel further comprises at least one third opening, and said USB connector is positioned in said third opening and coupled to said USB interface for connecting said computer peripheral device with a USB interface.

14. A KVM switch according to claim 9, wherein said computer connection interface unit can switch a setup status by pressing a hot-key command or an OSD of said computer host.

15. A KVM switch according to claim 10, wherein said connector comprises a HDB-15 adaptor.

16. A KVM switch according to claim 13, wherein said USB connector comprises a USB-B adaptor.

17. A KVM switch according to claim 14, wherein said hot-key command comprises <Ctrl><Ctrl>, <Caps Lock><Caps Lock>, Ctrl+Alt.

18. A HDB-15 cable, comprising
a first adaptor, coupled to a KVM switch;
a cable, comprising a distal end coupled to a first adaptor and another distal end split into a main cable and at least a secondary cable;
a second adaptor, coupled to said main cable, for connecting to a monitor; and
at least one third adaptor, coupled to said secondary cable, for connecting to a computer peripheral device.

19. A HDB-15 cable according to claim 18, wherein said first adaptor comprises a HDB-15 adaptor; said second adaptor comprises a VGA adaptor; said third adaptor comprises a USB adaptor and a PS/2 adaptor.
